(19) United States
(12) Patent Application Publication
(10) Pub. No.: US 2023/0113977 A1
(43) Pub. Date: Apr. 13, 2023

(54) NON-POLYMERIC COUPLING AGENT FORMULATIONS FOR WOOD POLYMER COMPOSITES

(71) Applicant: Arkema Inc., King of Prussia, PA (US)

(72) Inventors: Peter R. DLUZNESKI, King of Prussia, PA (US); William P. PAVLEK, King of Prussia, PA (US); Leonard H. PALYS, King of Prussia, PA (US); Michael B. Abrams, King of Prussia, PA (US); Marina DESPOTOPOULOU, King of Prussia, PA (US)

(21) Appl. No.: 17/914,377

(22) PCT Filed: Apr. 8, 2021
(86) PCT No.: PCT/US2021/026413

§ 371 Date: Sep. 26, 2022

Related U.S. Application Data
(60) Provisional application No. 63/007,424, filed on Apr. 9, 2020.

(51) Int. Cl. C08L 97/02; C08L 23/06; C08K 5/14; C08J 3/22

(52) U.S. Cl. CPC C08L 97/02; C08L 23/06; C08K 5/14; C08J 3/226; C08L 2207/062; C08J 2323/06; C08J 2397/02

(57) ABSTRACT

Non-polymeric coupling agent formulation for producing wood-polymer composites include at least one organic peroxide and a non-polymeric bio-based additive that includes at least one of a bio-based oil or a bio-based acid or derivatives of bio-based oils or acid is provided. The coupling agent formulations are capable of producing polymer matrix composites having improved strength and aging characteristics. The improved strength may be related to physical properties such as improved stiffness, toughness or tensile strength. A masterbatch utilizing the non-polymeric coupling agent formulation is provided, as well as a method making the masterbatch.

### FIELD OF THE INVENTION

This disclosure relates to non-polymeric coupling agent formulations for improving the compatibility and the properties of a polyolefin-wood matrix or wood product composites.

### BACKGROUND OF THE INVENTION

One process for making wood polymer composite decking is to melt blend a combination of wood flour and polyethylene in an extruder to form boards that mimic lumber. The blend of wood flour and polyethylene, however, is incompatible.

Poor compatibilization of wood and various polymers or blends thereof leads to cracks in the composite board, a decrease in the board's physical properties, and an increase in water absorption, all of which are undesirable. Water absorption decreases the composite's aging characteristics, i.e., retention of desirable physical properties over time. One approach to solve is this problem is to incorporate a maleic anhydride grafted polymer into the wood filler-polymer matrix blend. The maleic anhydride grafted polyethylene (MAH-g-PE) or maleic anhydride grafted polypropylene (MAH-g-PP) polymers are referred to as polymeric compatibilizers or polymeric coupling agents. These additives include for example maleated polyolefins such as the Polybond® series from Chemtura, the Fusabond® series from DuPont, the Exxelor® series from ExxonMobil and the Orevac® series from Arkema.

There is a need for coupling additives that build mechanical strength and reduce water absorption, especially for load-bearing applications and even more particularly for such load bearing applications that are exposed to an outside environment, for example, wood-polymer composite boards used for outdoor decking.

US 2017/0275462 discloses a thermoplastic polymer, cellulosic material, and a functional filler. The functional filler comprises inorganic particulates that are treated with surface treatment agents. The inorganic particulates include calcium carbonate, kaolin clay, talc, magnesium hydroxide, and gypsum. Surface treatment agents used to coat the inorganic particulates are specialty acrylates (e.g., beta-carboxy ethylacrylate, beta-carboxyhexylmaleimide). Surface treatments also include or one or more fatty acids. An optional peroxide additive comprising dicumyl peroxide, or 1, 1-di(tert-butylperoxy)-3,3,5-trimethylcyclohexane is disclosed and may be added to the high-density polyethylene (HDPE) polymer to promote crosslinking. The optional peroxide may be added to polypropylene (PP) to promote chain scission.

US 2014/0121307 discloses use of a modified lignin, hydroxypropyl lignin (HPL), HDPE, LDPE (low density polyethylene), PP and polystyrene. Hydrogen peroxide is blended with a polymeric compatibilizer. The compatibilizer is the standard grafted MAH on polyethylene (MAH-g-PE) or a copolymerized polyethylene where the MAH is in the polymer chain (as opposed to grafted onto the chain).

US 2004/0126515 discloses using a polyethylene polymer blended with wood particles to produce a composite. The polyethylene has a melt flow index (MFI) of less than about 2 g/10 min. Also disclosed is a bonding agent which is a polymer having an MFI greater than the polyethylene used in the wood-plastic composite. This bonding agent is a carboxylic acid or anhydride species that is chemically bonded to a polyethylene chain before use in a wood plastic composite. The application also discloses wood lignin and terpenes in a wood-plastic composite which can result in undesirable foaming.

U.S. Pat. No. 5,179,149 discloses the use of stand oils. Stand oils are heat treated, polymerized natural oils that are chemically and physically different from non-polymeric natural oils. The stand oils are made by polymerizing linseed, tung, soybean, fish, rapeseed, colza, or other natural oils or mixtures at high temperatures for several hours using organic peroxides. A method to prepare the stand oils is by heating natural oils and organic peroxides in a reactor at 200° C. to 280° C. The final material, referred to as the stand oil intermediate product, is ground to a powder and used to make nonwoven products. In a further step, the stand oil intermediate product is added to poly(ethylene propylene diene) terpolymer (EPDM), wood filler, PE, clay and t-butylperoxy benzoate, mixed and then pressed into a sheet and cured at 140° C.

U.S. Pat. No. 7,850,771 discloses processes for preparing aqueous emulsions of polyethylene wax, wood preservatives and optional agents such as tung oil, linseed oil, acrylic acid, organic acids using as free radical initiators azobisisobutyronitrile (AIBN) and hydrogen peroxide that make up the wood preservative composition. The use of alkyl acrylates that can be cured with AIBN, hydrogen peroxide, or potassium persulfate also is disclosed.

US 2020/0056020 discloses preparation of materials containing capstocks and cores, where the cores are comprised of bimodal polymer resin and a non-bio-based maleic anhydride.

There remains a need for a cost-effective, easy-to-use coupling agent for wood-polymer composites intended to be used as replacements for traditional wood lumber, particularly for outdoor applications such as decking.

### SUMMARY OF THE INVENTION

Non-polymeric coupling agent formulations for wood-polymer composites comprising: a) at least one organic peroxide (room temperature, which may or may not be functionalized) having a half-life of at least one hour at 98° C., preferably for at least three months, and b) at least one non-polymeric bio-based additive. One hour half life information for various organic peroxides can be found in Luperox® Organic Peroxides/High Polymers catalog by Arkema (Colombes Cedex), and incorporated herein in its entirety for all purposes. In addition to the half-life, the organic peroxides useful for the non-polymeric coupling agent formulations of the invention are solid in their pure state at 20° C. and exhibit no significant loss of peroxide assay at that same temperature for least one month.

The b) at least one non-polymeric bio-based additive is selected from the group consisting of: i) at least one natural oil or derivative thereof; ii) at least one natural acid, one natural anhydride, or esters thereof; iii) at least one natural solid compound; and iv) mixtures thereof. A non-polymeric coupling agent formulation may also comprise c) at least one sulfur containing compound. A non-polymeric coupling agent may also comprise an allyl-containing compound.

Also disclosed herein are non-polymeric coupling agent formulations which are combined with a masterbatch comprising filler(s), wood flour, saw dust, and/or powdered polyethylene or PE pellets.

### DETAILED DESCRIPTION

Unless otherwise indicated, all percentages herein are weight percentages.

“Polymer” as used herein means organic molecules with a weight average molecular weight higher than 20,000 g/mol, preferably higher than 50,000 g/mol, more preferably higher than 150,000, as measured by gel permeation chromatography.

The term, “dry” as used herein with respect to the wood or wood product filler for the wood-polymer composite, means up to an including 0 wt % to 1 wt %, up to 2 wt %, but no more than 5 wt % of water as measured by thermogravimetric analysis as weight loss until a constant mass has been achieved when heating the wood filler at 103° C. This method is described in “Methods to determine wood moisture and their applicability in monitoring concepts by Philipp Dietsch et al;., (Dr.—Ing., Research Associate and Chair of Timber Structures and Building Construction; Technische Universitat Munchen, Germany; Journal of Civil Structural Health Monitoring; Vol 5, p. 115-127 (2015). In addition, a device called “Sawdust moisture meter TK100W” from K J Industry Co. Ltd has a 0 wt % to 84 wt % moisture measuring range. This device can be used to measure the moisture content of various wood materials such as wood flour, sawdust, paillasse and bamboo powder.

Reducing the water content of wood flour or sawdust is important because water inhibits or even prevents bonding between wood fiber and polymer. Excess water can also cause undesirable porosity. Wood flour may have 4 wt % to 6 wt % or higher moisture content (water). Preferably, the wood flour after drying has a water content below 4 wt %, preferably about 3 wt %, more preferably about 2 wt %, more preferably about 1 w t% moisture content, even more preferably about 0.5 wt % or less.

The particle size of the wood flour ranges from 80 to 40 mesh (180-425 μm). Use of particle sizes outside this typical range may also be considered, e.g., up to 20 mesh (850 μm or 0.85 mm diameter) for example.

The term “wood flour” as used herein refers to plant-based fibers and nanocrystals, which may be derived from any source, including but not limited to hard wood type timber, soft wood timber, bamboo, rice hulls, corn husks, flax, kenaf, recycled or scrap paper, recycled or scrap cardboard, and which furthermore may be pulverized into particles with consistency ranging from a fine powder to particles with dimensions as large as 10 mm.

The terms “bio-based” and “natural” are used to denote materials and building blocks thereof that are found in nature, including but not limited to those that may be synthetically produced. In some embodiments, “bio-based” and “natural” further additionally denote materials and compositions derived from such bio-based and natural materials and building blocks, however produced, including those derived from man-made synthesis. The term “building block” as used refer means natural moieties that may be chemically modified to produce other compounds and products.

“Natural solids” means moieties in the solid phase and which are found in nature; natural solids includes moieties selected from the group consisting of anhydrides including chemically modified anhydrides, waxes such as carnauba wax, minerals such as aluminum sulfate, sodium aluminum sulfate, aluminum hydroxide, potassium aluminum sulfate ammonium aluminum sulfate (alum), potassium aluminum sulfate, aluminum lactate, ferrous sulfate, and stannous chloride.

Natural oils as referred to herein may comprise tung oil, oiticica oil, castor oil, sorbitan esters (e.g., sorbitan tristearate, sorbitan monolaurate, sorbitan monooleate, sorbitan dioleate, sorbitan trioleate, sorbitan monolinolenate, sorbitan dilinolenate, sorbitan trilinolenate), polysorbate 80, omega-3, limonene, myrcene and related natural terpene compounds described below, and mixtures thereof. Preferred natural oils include tung oil, oiticica oil, castor oil, polysorbate 80, sorbitan trisearate, sorbitan monolaurate, sorbitan dilinolenate, sorbitan monolinolenate, limonene, myrcene and mixtures thereof. More preferred natural oils include tung oil, oiticica oil, polysorbate 80, sorbitan monolinolenate, sorbitan monooleate, sorbitan trioleate, limonene and mixtures thereof. In some embodiments, the natural oils may possess at least one carbon-carbon double bond reactive to free radicals, preferably two carbon-carbon double bonds that are conjugated, more preferably three or more conjugated carbon-carbon double bonds. In some embodiments, the natural oils may be fully saturated with no carbon-carbon double bonds.

The chemically modified natural oils may comprise epoxidized soybean oil, epoxidized lecithin, epoxidized itaconic acid, epoxidized diallyl itaconate, epoxidized sorbitan dioleate, partially epoxidized limonene, partially epoxidized diallyl itaconate, partially epoxidized terpenes, partially epoxidized sorbitan dioleate, partially epoxidized sorbitan trilinolenate, or mixture thereof. Preferred are the partially epoxidized natural oils and epoxidized lecithin. More preferred include: partially epoxidized diallyl itaconate, partially epoxidized sorbitan dioleate, partially epoxidized limonene and partially epoxidized sorbitan trilinolenate. Even more preferred are partially epoxidized diallyl itaconate and partially epoxidized limonene.

The non-polymeric bio-based additive may comprise lecithin, various sugars, artificial sugars, oxidized sugars, sugar alcohols, phosphoproteins such as casein, or mixtures thereof. Lecithin and casein are preferred.

The non-polymeric bio-based additive may comprise oleic acid derivatives, such as sorbitan monooleate, sorbiatan dioleate, and sorbitan trioleate, or mixtures thereof. Sorbitan monooleate and sorbitan trioleate are preferred.

The non-polymeric natural solid compound may comprise naturally occurring minerals such as alum, aluminum sulfate, aluminum hydroxide, potassium aluminum sulfate, sodium aluminum sulfate, boric acid, disodium tetraborate (also known as sodium borate, or borax), ferrous sulfate, and stannous chloride.

The natural acids may comprise for example, abietic acid, benzoic acid, itaconic acid, succinic acid, tartronic acid, tannic acid, including their corresponding anhydride forms, and methyl esters of abietic acid and abalyn, and the like. The anhydrides may comprise for example, itaconic anhydride, succinic anhydride, allyl succinic anhydride, isononenyl succinic anhydride, and the like.

The organic peroxide may comprise small amounts of high boiling non-aromatic compounds such as mineral spirits or mineral oil useful as safety diluents. The organic peroxide formulation may also contain, polysorbate 80, polypropylene glycol, or mixtures thereof.

In some embodiments, at least one organic peroxide may be used with either elemental sulfur and/or a sulfur containing compound and at least one other coupling agent compound selected from natural oil, natural solid, acid, chemically modified oil or coagent. This formulation may or may not be made into a free flowing powder masterbatch dispersed on the various inert fillers and/or powdered polymers described herein.

Blends of these natural oils and derivatives thereof, natural acids, natural anhydrides, esters of natural acids and natural anhydrides, natural solids, and/or at least one sulfur containing compound and/or coagents with one or more organic peroxides are contemplated. Preferred are t-amyl peroxy and t-butyl peroxy type organic peroxides.

In some embodiments, an organic peroxide formulation may contain at least one stabilizer, including for example but not limited to at least one quinone type compound or at least one nitroxide type compound or a combination of these. In some embodiments, the peroxide formulation comprises at least one quinone compound or at least one nitroxide compound or a combination thereof and may also contain at least one allylic or more preferably a diallyl compound, even more preferably a triallyl compound as a coagent.

Other embodiment blends comprising at least one organic peroxide may comprise, consist of or consist essentially of (i) epoxidized soybean oil and either itaconic acid or tartronic acid, (ii), epoxidized soybean oil, itaconic acid, and tartronic acid; (iii) epoxidized soybean oil and either zinc oxide or magnesium oxide, with itaconic and/or tartronic acid.

The formulations of the invention may be made into a powder masterbatch, preferably free-flowing, dispersed on various inert fillers and/or powdered polymers described herein.

In some instances, a functionalized organic peroxide may be selected from those room temperature stable peroxides (i.e., having at least 1 hour half-life at 98° C.) that possess carboxylic acid, one or more double bonds capable of reacting with a free radical, methoxy or hydroxy functionality, such as for example t-butylperoxy maleic acid (Luperox® PNP-25 from Arkema). This carboxylic acid functionalized organic peroxide may be blended with various additives disclosed herein including acids such as itaconic acid, its anhydride and/or its allyl esters. The non-polymeric coupling agent formulation may further comprise dried wood flour, dried saw dust, cellulose acetate butyrate powder, chlorinated polyethylene powder, chlorosulfonated polyethylene powder and/or polyethylene powder or polyethylene pellet to create a novel non-polymeric coupling agent masterbatch.

These coupling agent formulations may also be extended on fillers or blends of fillers to provide a free-flowing powder product or masterbatch. Non-limiting examples of such fillers comprise calcium carbonate, Burgess Clay, precipitated silica, microcrystalline cellulose, cellulose acetate butyrate (CAB), calcium silicate, silica, fly ash, dried wood flour, dried saw dust, dried straw particles/flour, polyethylene in powder or pellet form, or mixtures thereof. Preferred are Burgess Clay, precipitated calcium carbonate, precipitated silica, calcium silicate, microcrystalline cellulose, dried wood flour, dried sawdust, cellulose acetate butyrate, high density polyethylene powder, polypropylene powder and mixtures thereof. Most preferred are Burgess clay, precipitated silica, calcium silicate, high density polyethylene powder, dried wood flour, dried sawdust and mixtures thereof.

In one embodiment, the non-polymeric coupling agent may completely replace the conventional polymeric grafted MAH compatibilizers in a wood polymer composite formulation. In another embodiment, the non-polymeric coupling agent formulation may partially replace a conventional polymeric MAH coupling agent in an existing wood polymer composite.

The non-polymeric coupling agent formulations may be added separately or as a masterbatch to wood flour and polyethylene. This composition may then be melt blended and extruded to form, for example, wood-polymer composite deck boards.

### Organic Peroxides

Suitable organic peroxides suitable for use in the practice of some embodiments of this invention may be selected from room temperature stable organic peroxides. The organic peroxide may be in liquid form, solid form, solid flake, solid powder form that is extended on inert filler, meltable solid form, or a pourable paste form. These various peroxide forms may be used in the coupling agent compositions disclosed herein. Suitable organic peroxides may be capable of decomposing and forming reactive free radicals when exposed to a source of heat, for example in an extruder.

The organic peroxide suitable for use in certain embodiments of the non-polymeric coupling agent composition for wood-polymer composites may be selected from those room temperature stable peroxides that possess carboxylic acid, methoxy or hydroxy functionality. “Room-temperature stable” in the context of this disclosure means an organic peroxide that has not decomposed, i.e., has retained its assay, after at least three months at 20° C. Room temperature stable organic peroxides in the context of this disclosure may be defined as having a half-life of at least 1 hour at 98° C. An exception to this rule applies to the diacyl solid peroxides: non-limiting examples such as dibenzoyl peroxide; dilauryl peroxide; 2, 4-dichlorobenzoyl peroxide; or para-methyl dibenzoyl peroxide which are thermally stable at ambient 20° C. temperatures but have a half-life shorter than 1 hour 98° C.

Non-limiting examples of suitable organic peroxides classes are diacyl peroxides, peroxyesters, monoperoxycarbonates, peroxyketals, hemi-peroxyketals, solid at ambient temperature (20° C.) peroxydicarbonates, and dialkyl peroxide classes are suitable, as are the t-butylperoxy and t-amylperoxy classes. In addition, cyclic organic peroxides, for example: Trigonox® 301 and Trigonox® 311 peroxides from Nouryon are contemplated. Suitable peroxides may be found in “Organic Peroxides” by Jose Sanchez and Terry N. Myers; Kirk Othmer Encyclopedia of Chemical Technology, Fourth Ed., Volume 18, (1996), the disclosure of which is incorporated herein by reference in its entirety for all purposes. Thermally stable functionalized peroxides with carboxylic acid, hydroxyl and/or possessing a free radical reactive unsaturated group are also suitable. The organic peroxide may contain small amounts of mineral spirits, mineral oil, or a food-grade white mineral oil to serve as safety diluents.

The organic peroxide may also be extended on inert fillers (e.g., wood flour, saw dust, bamboo flour, straw, straw flour, rice hulls, wheat straw, hemp, flax, peanut shell flour, scrap paper, scrap cardboard, Burgess clay, kaolin clay, calcium carbonate, silica, calcium silicate, and cellulose acetate butyrate) or used powder or pellet form as peroxide masterbatch on EPDM (ethylene propylene diene monomer rubber), EPM (ethylene propylene rubber) PE (polyethylene), HDPE (high density polyethylene) PP (polypropylene), microcrystalline wax, polycaprolactone) wherein the peroxide concentration could vary from 1 wt % to 80 wt %, preferably from 0.1 wt % to 60 wt %, more preferably from 0.1 wt % to 40 wt % depending upon the application.

Non-limiting examples of suitable organic peroxides are: di-t-butyl peroxide; t-butyl cumyl peroxide; t-amyl cumyl peroxide; dicumyl peroxide; 2,5-di(cumylperoxy)-2,5-dimethyl hexane; 2,5-di(cumylperoxy)-2,5-dimethyl hexyne-3; 4-methyl-4-(t-butylperoxy)-2-pentanol; 4-methyl-4-(t-amylperoxy)-2-pentanol; 4-methyl-4-(cumylperoxy)-2-pentanol; 4-methyl-4-(t-butylperoxy)-2-pentanone; 4-methyl-4-(t-amylperoxy)-2-pentanone; 4-methyl-4-(cumylperoxy)-2-pentanone; 2,5-dimethyl-2,5-di(t- butylperoxy)hexane; 2,5-dimethyl-2,5-di(t-amylperoxy)hexane; 2,5-dimethyl-2,5-di(t-butylperoxy)hexyne-3; 2,5-dimethyl-2,5-di(t-amylperoxy)hexyne-3; 2,5-dimethyl-2-t-butylperoxy-5-hydroperoxy hexane; 2,5-dimethyl-2-cumylperoxy-5-hydroperoxy hexane; 2,5-dimethyl-2-t-amylperoxy-5-hydroperoxy hexane; m/p-alpha, alpha-di(t-butylperoxy)diisopropyl benzene; meta-di(t-butylperoxy)diisopropyl benzene; para-di(t-butylperoxy)diisopropyl benzene; 1,3,5-tris(t-butylperoxyisopropyl)benzene; 1,3,5 -tris(t-amylperoxyisopropyl)benzene; 1,3,5-tris(cumylperoxyisopropyl)benzene; di [1,3-dimethyl-3-(t-butylperoxy)butyl] carbonate; di [1,3-dimethyl-3-(t-amylperoxy)butyl] carbonate; di [1,3-dimethyl-3-(cumylperoxy)butyl] carbonate; di-t-amyl peroxide; t-amyl cumyl peroxide; t-butylperoxy-isopropenylcumylperoxide; t-amylperoxy-isopropenylcumylperoxide; 2,4-diallyloxy-6-tert-butyl peroxide-1,3,5-trazine; 2,4-diallyloxy-6-tert-amyl peroxide-1,3,5-trazine; 2,4,6-tri(butylperoxy)-s-triazine; 1,3,5-tri [1-(t-butylperoxy)-1-methylethyl] benzene; 1,3,5-tri-[(t-butylperoxy)-isopropyl benzene; 1,3-dimethyl-3-(t-butylperoxy)butanol; 1,3-dimethyl-3-(t-amylperoxy)butanol; and mixtures thereof. Illustrative solid, room temperature stable peroxy dicarbonates include, but are not limited to: di(2-phenoxyethyl)peroxydicarbonate; di(4-t-butyl-cyclohexyl)peroxydicarbonate; dimyristyl peroxydicarbonate; dibenzyl peroxydicarbonate; and di(isobornyl)peroxydicarbonate. Solid diacyl peroxides include: dibenzoyl peroxide; 2,4-dichlorobenzoyl peroxides; and di(methylbenzoyl)peroxide.

Other dialkyl type organic peroxides which may be used singly or in combination with the other organic peroxides contemplated by the present disclosure are those selected from the group represented by the formula:

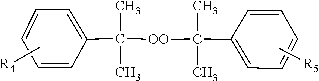

wherein R₄ and R₅ may independently be in the meta or para positions and are the same or different and are selected from hydrogen or straight or branched chain alkyls of 1 to 6 carbon atoms. Dicumyl peroxide and isopropylcumyl cumyl peroxide are illustrative.

Other dialkyl peroxides may include but are not limited to: 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3 -(t-butylperoxy)butyl N-[1-{3 -(1-methylethenyl)-phenyl} 1 -methylethyl] carbamate;

1, 3 -dimethyl-3 -(t-amylperoxy)butyl N-[1 - {3 (1-methylethenyl)-phenyl}-1-methylethyl]carbamate; 1 ,3 -dimethyl-3-(cumylperoxy))butyl N-[1-{3-(1 -methylethenyl)-phenyl}-1 -methylethyl]carbamate.

Other variants of dialkyl type peroxides which contain two different peroxide groups of varying chemical and/or thermal reactivity may be included in this invention. Non-limiting examples include: 2,5-dimethyl-(2-hydroperoxy-5-t-butylperoxy)hexane and 2,5-dimethyl-(2-hydroperoxy-5-t-amylperoxy)hexane.

In the group of diperoxyketal type organic peroxides, suitable compounds may include: 1, 1-di(t-butylperoxy)-3,3, 5-trimethylcyclohexane; 1, 1-di(t-amylperoxy)-3,3 , 5-trimethylcyclohexane; 1 ,1-di(t-butylperoxy)cyclohexane; 1,1 -di(t-amylperoxy)cyclohexane; n-butyl4,4-di(t-amylperoxy)valerate; ethyl 3,3-di(t-butylperoxy)butyrate; 2,2-di(t-amylperoxy)propane; 3 ,6,6, 9,9-pentamethyl-3 -ethoxycabonylmethyl -1,2,4 5 -tetraoxacyclononane; n-butyl-4,4-bis(t-butylperoxy)valerate; ethyl-3,3 -di(t-amylperoxy)butyrate; and mixtures thereof.

Other organic peroxides that may be used according to at least one embodiment of the present disclosure include benzoyl peroxide, OO-t-butyl-O-hydrogen-monoperoxy-succinate and OO-t-amyl-O-hydrogen-monoperoxy-succinate.

Illustrative cyclic ketone peroxides are compounds having the general formulae (I), (II) and/or (III).

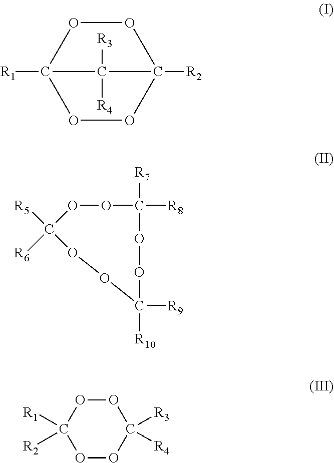

wherein R₁ to R₁₀ are independently selected from the group consisting of hydrogen, C1 to C20 alkyl, C3 to C20 cycloalkyl, C6 to C20 aryl, C7 to C20 aralkyl and C7 to C20 alkaryl, which groups may include linear or branched alkyl properties and each of R1 to R10 may be substituted with one or more groups selected from hydroxy, C1 to C20 alkoxy, linear or branched C1 to C20 alkyl, C6 to C20 aryloxy, halogen, ester, carboxy, nitride and amido.

Some non-limiting examples of suitable cyclic ketone peroxides include but are not limited to: 3,6,9, triethyl-3,6,9-trimethyl-1,4,7-triperoxynonane (or methyl ethyl ketone peroxide cyclic trimer), methyl ethyl ketone peroxide cyclic dimer, and 3,3,6,6,9,9-hexamethyl-1,2,4,5-tetraoxacyclononane.

Non-limiting illustrative examples of peroxy esters include: 2,5-dimethyl-2,5-di(benzoylperoxy)hexane; t-butylperbenzoate; t-butylperoxyacetate; t-butylperoxy-2-ethyl hexanoate; t-amylperbenzoate; t-amyl peroxy acetate; t-butyl peroxy isobutyrate; 3-hydroxy-1,1-dimethyl t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate. Illustrative monoperoxy carbonates include: OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,1-tris[2-(cumylperoxy-carbonyloxy)ethoxymethyl]propane; OO-t-amyl-O-isopropylmonoperoxy carbonate.

Other peroxides that may be used according to at least one embodiment of the present disclosure include the functionalized peroxyester type peroxides: OO-t-butyl-O-hydrogen-monoperoxy-succinate; OO-t-amyl-O-hydrogen-monoperoxysuccinate; OO-t-amylperoxymaleic acid and OO-t-butylperoxymaleic acid.

Also suitable in the practice of this invention is an organic peroxide branched oligomer comprising at least three peroxide groups comprises a compound represented by structure below:

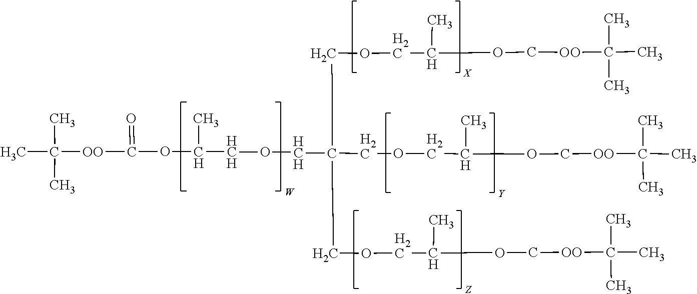

wherein the sum of W, X, Y and Z is 6 or 7. One example of this type of uniquely branched organic peroxide is the tetrafunctional polyether tetrakis(t-butylperoxycarbonate). An example of this type of peroxide is Luperox® JWEB50 (Arkema).

Illustrative hemi-peroxyketal class of organic peroxides include: 1-methoxy-l-t-amylperoxycyclohexane; 1-methoxy-l-t-butylperoxycyclohexane; 1-methoxy-l-t-amylperoxy-3,3,5 trimethylcyclohexane; 1-methoxy-l-t-butylperoxy-3,3,5 trimethylcyclohexane. An example of this type of peroxide is Luperox® V10 (Arkema) which is 93% assay 1-methoxy-1,1-dimethyl propyl peroxycyclohexane.

Illustrative diacyl peroxides include but are not limited to: di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide; succinic acid peroxide; dibenzoyl peroxide; di(2,4-dichloro-benzoyl)peroxide. Imido peroxides of the type described in PCT Application publication WO9703961 Al are also contemplated as suitable for use and incorporated by reference herein for all purposes.

Functionalized organic peroxides are suitable for use in the non-polymeric coupling agent formulation for wood-polymer composites. A non-limiting example of a functionalized organic peroxide is t-butylperoxy maleic acid. Non-limiting examples of a functionalized peroxide are t-butylperoxy maleic acid; t-amylperoxy maleic acid; t-butylperoxy-isopropenylcumylperoxide; t-amylperoxy-isopropenylcumylperoxide; 4-methyl-4-(t-butylperoxy)-2-pentanol; 4-methyl-4-(t-amylperoxy)-2-pentanol; 4-methyl-4-(cumylperoxy)-2-pentanol; 2,5-dimethyl-(2-hydroperoxy-5-t-butylperoxy)hexane and 2,5-dimethyl-(2-hydroperoxy-5-t-amylperoxy)hexane; 2,4-diallyloxy-6-tert-butyl peroxide-1,3,5-trazine; 2,4-diallyloxy-6-tert-amyl peroxide-1,3,5-trazine; and mixtures thereof. Preferred organic peroxides include: t-butylperoxymaleic acid; 1-methoxy-1-t-amylperoxycyclohexane; dilauryl peroxide; t-butylperoxy-2-ethylhexanoate; 1,1 -di(t-butylperoxy)-3 ,3 , 5-trimethylcyclohexane; 1,1-di(t-amylperoxy)cyclohexane; 1,1 -di(t-butylperoxy)cyclohexane; t-butylperoxy-3,5,5-trimethylhexanonate; t-amylperoxyacetate; t-butylperoxyacetate; t-amylperbenzoate; t-butylperbenzoate; OO-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; dicumyl peroxide; Luperox® JWEB-50, a polyether poly-t-butylperoxycarbonate (Arkema); Luperox® 313, a complex mixture of peroxides and containing <15 wt % t-butyl cumyl peroxide (Arkema); Luperox® D-68, a complex mixture of dicumyl peroxide, di-t-butylperoxydiisopropylbenzene and t-butyl cumyl peroxide (Arkema); Luperox® D-446-B, a complex mixture of di-t-butylperoxydiisopropylbenzene and t-butyl cumyl peroxide (Arkema); t-butyl cumyl peroxide; t-butylperoxy-isopropenylcumylperoxide; m/p-di-t-butylperoxydiisopropylbenzene) and mixtures thereof.

More preferred peroxides are: t-butylperoxymaleic acid; 1-methoxy-1-t-amylperoxycyclohexane; dilauryl peroxide; t-butylperoxy-2-ethylhexanoate; 1,1-di(t-butylperoxy)-3,3,5-trimethylcyclohexane; 1,1-di(t-amylperoxy)cyclohexane; 1,1-di(t-butylperoxy)cyclohexane; t-butylperoxy-3,5,5-trimethylhexanonate; t-amylperoxyacetate; t-butylperoxyacetate; t-amylperbenzoate; t-butylperbenzoate; OO-t-butyl-O-isopropylmonoperoxy carbonate; OO-t-amyl-O-isopropylmonoperoxy carbonate; OO-t-butyl-O-(2-ethyl hexyl)monoperoxy carbonate; OO-t-amyl-O-(2-ethyl hexyl)monoperoxy carbonate; dicumyl peroxide; Luperox® 313, a complex mixture of peroxides and containing <15 wt % t-butyl cumyl peroxide (Arkema); Luperox® D-68, a complex mixture of dicumyl peroxide, di-t-butylperoxydiisopropylbenzene and t-butyl cumyl peroxide (Arkema); t-butylperoxy-isopropenylcumylperoxide; m/p-di-t-butylperoxydiisopropylbenzene) and mixtures thereof.

Even more preferred are: t-butylperoxymaleic acid; Luperox®LP, t-butylperoxy-2-ethylhexanoate; 1,1-di(t-butylperoxy)-3,3,5-trimethylcyclohexane; 1,1-di(t-amylperoxy)cyclohexane; 1,1-di(t-butylperoxy)cyclohexane; t-butylperoxy-3,5,5-trimethylhexanonate; t-amylperbenzoate; t-butylperbenzoate; OO-t-butyl-O-isopropylmonoperoxy carbonate; OO-t-amyl-O-isopropylmonoperoxy carbonate; OO-t-butyl-O-(2-ethyl hexyl)monoperoxy carbonate; Luperox® 313, a complex mixture of peroxides and containing <15 wt % t-butyl cumyl peroxideArkema); Luperox® D-68, a complex mixture of dicumyl peroxide, di-t-butylperoxydiisopropylbenzene and t-butyl cumyl peroxide (Arkema); t-butylperoxy-isopropenylcumylperoxide; m/p-di-t-butylperoxydiisopropylbenzene and mixtures thereof.

Even more preferred peroxides used in this invention are: Luperox® 231, Luperox® TBEC, Luperox® TAEC, Luperox® TAIC, Luperox® TBIC, Luperox® 531M80, Luperox® P, Vul-Cup® 40KE, Luperox® V10, Luperox® 331M80, Luperox® 533M75, Di-Cup® 40KE, Luperox® RTM, Luperox® F40M-SP, Luperox®F40-SP2, t-butylperoxy-isopropenylcumylperoxide, Luperox® 0801, Luperox® D16, Di-Cup® 40-SP2, Vul-Cup® 40-SP2, Luperox®0101, Luperox®HP101XLP, Luperox®AIR®XL80, Luperox®313, Luperox®D-68, Luperox® D-446-B, Luperox®DTA and Luperox®130.

### Non-Polymeric Bio-based Additives

Non-limiting examples of suitable non-polymeric bio-based additives to include in the non-polymeric coupling agent formulation for wood-polymer composites are those that may possess at least some unsaturation, i.e., a carbon-carbon double bond that is reactive to peroxide free radicals. However, in some cases the bio-based additives may be saturated, i.e., those that do not contain a free radical reactive double bond. Non limiting examples of saturated bio-based saturated compounds are natural sugars, modified sugars that are referred to as artificial sweeteners, oxidized sugars, sugar alcohols, organic acids, e.g. tartronic acid and tannic acid.

Organic molecules comprising at least one carbon-carbon double bond may be used as the non-polymeric bio-based additive in the non-polymeric coupling agent formulation for wood-polymer composites. Non-limiting specific examples of suitable unsaturated organic compounds include tung oil; oiticica oil; castor oil; lecithin;, farnesenes; limonene; oleate derivatives such as sorbitan monooleate, sorbitan dioleate, and sorbitan trioleate; abietic acid; abalyn;, itaconic acid; succinic acid; allylsuccinic acid; and anhydrides of the acids. Preferred are tung oil, oiticica oil, castor oil, lecithin, limonene, abietic acid, itaconic acid, itaconicanhydride, succinic acid, succinic anhydride, allylsuccinic acid, allylsuccinic anhydride, sorbitan monoleate, sorbitan trioleate, and polysorbate 80.

Non-polymeric bio-based additives such as itaconic acid and succinic acid and allylsuccinic acid may have superior health, environment, and safety profiles and therefore may be preferred.

Plant or animal sourced fatty acid alkyl esters that comprise at least one carbon-carbon double bond are suitable to be used in embodiments of the invention as disclosed herein. Such fatty acid esters may include a C1 to C8 alkyl ester of a C8-C22 fatty acid. In one embodiment, fatty acid alkyl esters of vegetable oils such as fatty acid alkyl esters of olive oil, peanut oil, corn oil, cottonseed oil, soybean oil, linseed oil, and/or coconut oil are used. Linseed oil is preferred. In one embodiment, methyl soyate is used. In other embodiments, the fatty acid alkyl ester may be selected from the group consisting of biodiesel and derivatives of biodiesel. In another embodiment, the fatty acid alkyl ester is a castor oil-based fatty acid alkyl ester. The alkyl group present in the fatty acid alkyl ester may be, for example, a C1-C6 straight chain, branched or cyclic aliphatic group such as methyl, ethyl, n-propyl, isopropyl, n-butyl, sec-butyl, cyclohexyl and the like. The fatty acid alkyl ester may comprise a mixture of esters containing different alkyl groups. The non-polymeric bio-based additives may be selected from fatty acids or derivatives thereof, monoglycerides, diglycerides, triglycerides, animal fats, animal oils, vegetable fats, or vegetable oils or combinations thereof. Examples of such non-polymeric bio-based additives include, without limitation, linseed oil, soybean oil, cottonseed oil, ground nut oil, sunflower oil, rape seed oil, canola oil, sesame seed oil, olive oil, com oil, safflower oil, peanut oil, sesame oil, hemp oil, neat's food oil, whale oil, fish oil, castor oil, tall oil, and combinations thereof Also suitable are algae oil, avocado oil, castor oil, flax oil, fish oil, grapeseed oil, hemp oil, jatropha oil, jojoba oil, mustard oil, dehydrated castor oil, palm oil, palm stearin, rapeseed oil, safflower oil, tall oil, olive oil, tallow, lard, chicken fat, linseed oil, linoleic oil, coconut oil, carnauba wax and mixtures thereof. Linoleic oil, castor oil, and carnauba wax are preferred. Epoxidized versions of any of the preceding natural oils may also be utilized in the non-polymeric coupling agent formulation for wood-polymer composites. Partially epoxidized linoleic oil is preferred.

Naturally-occurring terpenes and derivatives thereof are also suitable to be used as the non-polymeric bio-based additive in the non-polymeric coupling agent formulation for wood-polymer composites. Monoterpenes, monoterpenoids, modified monoterpenes, diterpenes, modified diterpenes, triterpenes, modified triterpenes, triterpenoids, sesterterpenes, modified sesterterpenes, sesterterpenoids, sesquarterpenes modified sesquarterpenes, sesquarterpenoids, and oxygen-containing derivatives of hemiterpenes, are also non-limiting examples of suitable non-polymeric bio-based additives that may be included in the non-polymeric coupling agent formulation for wood-polymer composites. Non-limiting particular examples of such non-polymeric bio-based additives are limonene, carvone, humulene, taxidiene, squalene, farnesenes, farnesols, cafesrol, kahweol, cembrene, taxidiene, retinol, retinal, phytol, geranylfarnesol, shark liver oil, licopene, ferrugicadiol, and tetraprenylcurcumene, gamma-carotene, alpha-carotene, and beta-carotene. Epoxidized versions of these terpenes are also suitable.

Vitamins having at least one reactive carbon-carbon double bond may be used as the non-polymeric bio-based additive in certain embodiments of the non-polymeric coupling agent formulation for wood-polymer composites. Non-limiting examples of these are vitamin K1 (phytonadione) and vitamin K2 (menaquinone). Saturated vitamins that can participate in organic peroxide reactions having desirable abstractable hydrogens may be used in some embodiments. Non-limiting examples of these saturated vitamins are vitamin B complex type compounds, particularly folic acid, vitamin B12, vitamin B1 (thiamine), as well as vitamin K3 (menadione).

Other non-polymeric bio-based additives useful in the non-polymeric coupling agent formulation for wood-polymer composites disclosed herein include raw honey, honey, glucose, fructose, sucrose, galactose, glycerine and urea. Oxidized versions of these sugars are also suitable in certain embodiments. For example glucaric acid (oxidized glucose) and oxidized sucrose can also be used. Artificial sugars/sweeteners may be used in some embodiments. Non-limiting examples of these are saccharin, acesulfame, aspartame, neotame, and sucralose. Certain amino acids may also be used as the non-polymeric bio-based additive in the non-polymeric coupling agent formulation for wood-polymer composites. Non-limiting examples of suitable amino acids are arginine, lysine, glutamine, histadine, cysteine, serotonin, tryptophan, asparagine, glutamic acid, glycine, aspartic acid, serine and threonine.

Other non-polymeric bio-based additives that may be included in the non-polymeric coupling agent formulation for wood-polymer composites are for example, a blend of epoxidized bio-based oil and bio-sourced itaconic acid or anhydride. In place of the epoxidized bio-based oil, un-epoxidized bio-based oil may be used. A blend of epoxidized soybean oil and bio-based itaconic acid are useful. Other bio-based acids include, for example natural acids such as abietic acid including their corresponding anhydride forms, tartronic acid, and tannic acid. Also included is abalyn (methyl ester of abietic acid). Blends of epoxidized bio-based oils; bio-based oils (e.g., tung, limonene, oiticica oil) and di- or tri- functional acrylates and/or methacrylate coagents may be used in the formulation, such as those available from Sartomer under the tradenames Sartomer®, Saret®, and Sarbio®. The latter are especially preferred since they are bio-based.

Non-limiting examples of coagents include allyl methacrylate, triallyl cyanurate, triallyl isocyanurate, trimethyloylpropane trimethacrylate (SR-350®), trimethyloylpropane triacrylate (SR-351®)), zinc diacrylate, and zinc dimethacrylate. According to particular embodiments, the ratio of the coagent(s) to the organic peroxide(s) (coagent:peroxide) is between about 100:1 to 1:100; 50:1 to 1:50; 25:1 to 1:25; 10:1 to 1:10.

Pentaerythritol with and without the organic peroxide may be used. Erythritol, sorbitol, mannitol, maltitol, lactitol, isomalt, xylitol or other sugar alcohols may be used.

A blend of zinc oxide, magnesium oxide and/or calcium oxide with bio-based additive and the organic peroxides disclosed herein may be included in the non-polymeric formulation for wood-polymer composites. Zinc-di(itaconate)salt may be included in the non-polymeric coupling agent formulation for wood-polymer composites.

Lecithin, i.e., mixtures of glycerophospholipids including phosphatidylcholine, phosphatidylethanolamine, phosphatidylinositol, phosphatidylserine, and phosphatidic acid may be used in the non-polymeric coupling agent formulation for wood-polymer composites. Sorbitan monoleate, sorbitan dioleate and polysorbate 80 may also be included.

Other non-polymeric bio-based additives or naturally occurring compounds that may be included in the non-polymeric coupling agent formulation for wood-polymer composites are for example “natural solids” such as alum, aluminum sulfate, potassium aluminum sulfate, ammonium hydroxide, ammonium aluminum sulfate, boric acid, and disodium tetraborate (also known as sodium borate, or borax), aluminum lactate, ferrous sulfate, and stannous chloride.

Preferred natural solid additives used in the practice of this invention include potassium aluminum sulfate, ammonium aluminum sulfate, alum, allylsuccinic anhydride, succinic anhydride, carnauba wax, casein, itaconic anhydride, and tung oil. More preferred natural solid additives for the wood-polymer composites include potassium aluminum sulfate, ammonium aluminum sulfate, alum, allylsuccinic anhydride, succinic anhydride, carnauba wax, and itaconic anhydride.

In some embodiments, the non-polymeric coupling agent formulation for wood-polymer composites may comprise both non-polymeric bio-based additives possessing at least some unsaturation, such as itaconic acid, and non-polymeric bio-based “natural solid” additives, such as alum.

### Amounts of the Non-Polymeric Bio-Based Additive and the Organic Peroxide in the Non-Polymeric Coupling Agent Formulation for Wood-Polymer Composites

In some embodiments the non-polymeric coupling agent formulation for wood-polymer composites may comprise from 1% to 99% by total weight of the formulation of the organic peroxide and from 99% to 1% by weight of the non-polymeric bio-based additive.

According to particular embodiments, the at least one organic peroxide may be included in the non-polymeric coupling agent formulation for wood-polymer composites in an amount from 1 wt % to 95 wt %, or from 5 wt % to 95 wt % 10 wt % to 90 wt %, or from 20 wt % to 99 wt %, or from 30 wt % to 90 wt % or from 40 wt % to 75 wt %, or from 40 wt % to 70 wt %, or from 40 wt % to 65 wt %, or from 45 wt % to 80 wt %, or from 45 wt % to 75 wt %, or from 45 wt % to 70 wt %, or from 45 wt % to 65 w t%, or from 50 wt % to 98 wt %, or from 50 wt % to 75 wt %, or from 50 wt % to 70 wt %, or from 50 wt % to 65 wt %, from 50 wt % to 60 wt %, from 1 wt % to 50 wt %; or from 1 wt % to 40 wt %; or from 1 wt % to 25 wt % based on the total formulation.

According to particular embodiments, the at least one non-polymeric bio-based additive may be included in the non-polymeric coupling agent formulation for wood-polymer composites in an amount from 95 wt % to 5 wt %, or from 90 wt % to 10 wt %, or from 99 wt % to 20 wt %, or from 90 wt % to 30 wt % or from 75 wt % to 40 wt %, or from 70 wt % to 40 wt %, or from 65 wt % to 40 wt %, or from 80 wt % to 45 wt %, or from 75 wt % to 45 wt %, or from 70 wt % to 40 wt %, or from 65 wt % to 45 wt %, or from 98 wt % to 50 wt %, or from 75 wt % to 50 wt %, or from 70 wt % to 50 wt %, or from 65 wt % to 50 wt %, from 60 wt % to 50 wt %, based on the total weight of the non-polymeric coupling agent formulation for wood-polymer composites.

The ratio by weight of the organic peroxide to the non-polymeric bio-based additive may be from 1:1000 to 1000:1 or from 1:100 to 100:1, or from 1:9 to 9:1 or from 4:5 to 5:4 or from 1:5 to 5:1 or from 1:1 to 1:2 or from 2:1 to 3:1 or from 1:9 to 1:1 or from 1:1 to 9:1 or from 2:1 to 1:1. Organic peroxide to additive ratio may be 1:40 to 1:1; 1:20 to 1:1; 1:10 to 1:1; 1:5 to 1:1; or 1:3 to 1:1.

### Polymeric Matrix Materials for Wood-Polymer Composites

Suitable polymeric matrix materials for the wood-polymer composites include but are not limited to polyethylene and ethylene copolymers, including but not limited to LLDPE (linear low density polyethylene), HDPE (high density polyethylene), and/or LDPE (low density polyethylene). All preferably have a high melt flow index (MFI) of <40 g/10 min; preferably <20 g/10 min; more preferably <10 g/10 min; more preferably <5 g/10; even more preferred <1 g/10 min, most preferably <0.5 g/10 min at 190° C. with a 2.15 kg load as described in test method ASTM 01238. The polyethylenes used in this invention are preferably high molecular weight wherein the molecular weight for the polyethylene grades start at about 50,000 g/mole to 200,000 g/more, up to about 250,000 g/mole for the types of PE comprising LDPE, LLDPE, MDPE (medium density polyethylene) and HDPE or blends thereof from virgin or recycled sources. Ultrahigh molecular weight polyethylene (UHWMPE) may also be present (for example in the recycled PE stream) whose molecular weight is 3,000,000 g/mole up to 7,500,000 g/mole. Polymers such as poly(vinyl chloride) and poly(ethylene vinyl acetate) may also be suitable for use as the matrix material in wood-polymer composites in certain embodiments.

Preferred polymeric matrix materials for the wood-polymer composites include recycled polyethylene, wherein the recycled can be a mixed stream of UHMWPE, HDPE, MDPE, LDPE, LLDPE; or virgin grades of HDPE, LDPE, LLDPE.

Most preferred polymeric matrix materials for the wood-polymer composites include UHMWPE, HDPE and MDPE.

### Fillers for the Wood-Polymer Composites

Wood flour is a well known filler in wood-polymer composite deck boards. Wood flour is finely pulverized wood that has a consistency fairly equal to sand or sawdust, but can vary considerably, with particles ranging in dimensions from a fine powder to roughly that of a grain of rice. Most batches of wood flour have the same consistency throughout. Higher quality wood flour is made from hardwoods because of its durability and strength. Lower grade wood flour may be made from sapless softwoods such as pine or fir. There is always a need for better and/or more economical fillers to replace wood flour. The natural fillers that are useful in the practice of the present invention include but are not limited to rice hull powder, straw powder or fibers e.g., wheat straw; bamboo fiber, flax, jute, hemp, cellulose, ground wood, saw dust, palm fiber, bagasse, peanut shells, chitin, and kenaf fibers. Scrap paper and cardboard may also be used, alone or in combination with wood flour or sawdust. The wood flour may be produced from soft wood, hard wood or a blend. Optionally, the lignin is removed from the wood flour.

Sawdust or wood shavings (a by-product or waste product composed of fine particles of wood) may also be suitable for use as the filler in wood-polymer composites in certain embodiments.

Another filler is ground recycled truck and/or passenger tires. Worn tires may be ground into a powder useful in this invention. The amount of the ground tire may be 50 wt % to 1 wt % of the composite.

One exemplary embodiment of this invention comprises ground recycled rubber tire filler with wood flour, polyethylene, at least one coupling agent, and at least one organic peroxide. Other fillers that may be used in combination with wood flour/wood saw dust include chlorinated polyethylene powder and chlorosulfonated polyethylene powder. Cellulose acetate butyrate (CAB) may be used in certain embodiments as a filler. The preferred CAB grade will have an upper melting point no higher than 160° C., preferably no higher than 150° C., even more preferred no higher than 145° C. and most preferred less than 143° C. The most preferred grades of CAB that may be included as a filler have a butyryl content of approximately 52%. Non-limiting examples are: Eastman Chemical Cellulose Acetate Butyrate (CAB-551-0.2) and (CAB-551-0.01).

Preferred fillers for the wood-polymer composites include wood flour made from hardwood and/or softwood, including blends. Other fillers which may be combined with wood flour are saw dust and fine wood shavings. Most preferred fillers include wood flour made from hardwood.

### Improved Properties

Properties of the wood-polymer composite that may be improved or changed due to the inclusion of the non-polymeric coupling agent formulation for wood-polymer composites may include but are not limited to: improved compatibility between the polymer matrix and the wood filler, reduced water absorption, improved stiffness, improved impact resistance, improved compatibility with other polymers, improved compatibility with fillers and allowing the increased use of lower cost ground recycled materials e.g., paper, cardboard, scrap rugs, tires, polyethylene plastic bags/bottles and recycled PET containers, for example. The use of recycled materials provides a useful product while reducing a waste stream.

For example, the wood-polymer composite including the non-polymeric coupling agent formulation for wood-polymer composites as disclosed herein may be more compatible with other polymers, such that the polymer matrix may comprise a polyethylene and another polymer. Non-limiting examples of other such polymers are poly(vinyl alcohol)s, polyacrylates and copolymers of poly(vinyl alcohol)s or polyacrylates. Elium® resin (Arkema) may be considered. Also contemplated in small amounts<2 wt % to <1 wt % of the entire formulation are fluoropolymers such as polyvinylidine fluoride (PVDF), e.g. Kynar® (Arkema) and PTFE.

The non-polymeric coupling agent formulation for wood-polymer composites may be in the form of a solid or a liquid, depending on the form of the organic peroxide and the form of the non-polymeric bio-based additive. The non-polymeric coupling agent formulation for wood-polymer composites may be in the form of a masterbatch formulation.

### Masterbatch

A coupling agent masterbatch for wood-polymer composites is provided. The coupling agent masterbatch for wood-polymer composites may comprise, consist of, or consist essentially of a) at least one organic peroxide; b) at least one non-polymeric bio-based additive; and c) a carrier for the non-polymeric coupling agent masterbatch. The a) at least one organic peroxide is a room temperature organic peroxide and has a half-life of at least one hour at 98° C. The b) at least one non-polymeric bio-based additive is selected from the group consisting of: i) at least one natural oil or derivative thereof ii) at least one natural acid, anhydride, including esters thereof; iii) natural acids, and iv) mixtures thereof. The a) at least one organic peroxide and the b) at least one non-polymeric bio-based additive are described above.

As is known in the art, a masterbatch is a concentrated mixture of the non-polymeric coupling agent formulation for wood-polymer composites that is added to polymer matrix and wood filler that are processed (compounded) into the finished article, such as a deck board.

### Carriers for the Non-Polymeric Coupling Agent Masterbatch

The carrier for the coupling agent masterbatch for wood-polymer composites may comprise, consist of, or consist essentially of one or more of the polymer and or wood filler components of the final wood-polymer composite. For example, the non-polymeric coupling agent formulation comprising the organic peroxide and the bio-based additive as described above may be combined with wood flour, sawdust, polyethylene, calcium carbonate, synthetic calcium silicate, Burgess Clay, precipitated silica, microcrystalline cellulose, fly ash, dried wood flour, dried saw dust; dried straw particles, and combinations thereof In some embodiments, particulate materials as the carrier may be preferred, since the masterbatch may be prepared by blending a liquid formulation of the organic peroxide and the bio-based additive with the particulate material to form a free-flowing, non-caking, particulate masterbatch.

Non-limiting examples of suitable particulate carrier materials for the masterbatch are polyethylene powder, pelleted polyethylene, dried saw dust; dried wood flour, bamboo flour, hemp flour, kenaf fibers, scrap paper, scrap cardboard, cellulose acetate butyrate, and combinations thereof Also suitable are inert carriers, for examples e.g., silica, fumed silica, precipitated silica, talc, calcium carbonate, clay, Burgess clay, kaolin, fly ash, powdered polyethylene, pelleted polyethylene.

In another embodiment, the carrier material may comprise, consist of, or consist essentially of a low-melting wax, for example. The organic peroxide and the bio-based additive may be melt-blended with the wax, and the resulting masterbatch is then pelleted. Only small amounts of these waxes typically are added, such that the final wood-polymer composite material comprises less than 5 wt % , preferably less than 3 wt %, more preferably less than 1 wt % of the low melting wax. Suitable waxes include, but are not limited to bio-based waxes, such as beeswax, soy wax, bayberry wax, candelilla wax, carnauba wax, castor wax, vegetable wax, ouricury wax, rice bran wax, lanolin, and the like. Others may include the known non-bio-based petroleum based waxes.

The concentration of the organic peroxide and the bio-based additive and/or other additives disclosed herein, combined together in the masterbatch as wt% of the masterbatch may be varied as necessary depending on the let-down and the desired concentration of the coupling agent formulation the final wood-polymer composite. Non-limiting examples of suitable concentrations in the masterbatch may range from 40-65 wt %, or from 30-75 wt %, or from 50-70 wt %, or from 40-50 wt % of the organic peroxide and bio-based stabilizer, but the range also may be from 1 wt % to 80 wt % or from 2 wt % to 60 wt % or from 5 wt % to 50 wt % or from 10 wt % to 40 wt % depending upon the peroxide(s),bio-based additives and other additives chosen for the masterbatch blend.

### Stabilizers for the Organic Peroxide

The non-polymeric coupling agent formulation for wood-polymer composites may comprise, consist of, or consist essentially of stabilizers for the organic peroxide, for example at least one quinone type compound. In some instances, if the at least one quinone compound is used as stabilizer for the organic peroxide, at least one allylic compound, preferably a triallyl compound may also be included with organic peroxide. Non-limiting examples of the allylic compounds are TAC (triallyl cyanurate), TAIC (triallylisocyanurate), triallyl trimellitate, diallyl maleate, diallyl tartrate, diallyl phthalate, diallyl carbonate, allylphenylether, allylmethacrylate and the higher molecular weight allylmethacrylate oligomers sold by Sartomer.

In some embodiments, at least one stabilizer or free radical trap may be selected from the group consisting of nitroxides (e.g., 4-hydroxy-TEMPO) and quinones, such as mono-tert-butylhydroquinone (MTBHQ). These stabilizers, referred to as free radical traps (i.e., any agent that interacts with free radicals and inactivates them). and any such agent as known to those of ordinary skill in the art can be used. Other stabilizer include olive leaf oil (oleuropein), Irganox® 1076, Irganox® 1010, and Vitamin K1, K2 and K3. As used herein, the term “quinone” includes both quinones and hydroquinones. Non-limiting examples of quinones include mono-tert-butylhydroquinone (MTBHQ), hydroquinone, hydroquinone mono-methyl ether (HQMME) (also known as 4-methoxy phenol), mono-t-amylhydroquinone, hydroquinone bis(2-hydroxyethyl) ether, 4-ethoxy phenol, 4-phenoxy phenol, 4-(benzyloxy) phenol, 2,5-bis (morpholinomethyl) hydroquinone, and benzoquinone. Preferred stabilizers used in this invention include MTBHQ; HQMME; mono-t-amylhydroquinone, Irganox® 1010 and 4-OH TEMPO. More preferred stabilizers include mono-tert-butylhydroquinone (MTBHQ), hydroquinone and hydroquinone mono-methyl ether (HQMME) (also known as 4-methoxy phenol). Even more preferred is the stabilizer MTBHQ.

### Methods of Producing the Coupling Agent Masterbatch

A method of producing a coupling agent masterbatch for wood-polymer composites is provided. The method may comprise, consist of, or consist essentially of, the steps A) and B).

Step A) may comprise, consist of, or consist essentially of combining: a) at least one organic peroxide, and b) at least one non-polymeric bio-based additive to form a coupling agent formulation for wood-polymer composites.

The a) organic peroxide has a half-life of at least one hour at 98° C., determined from dilute solution kinetics by direct peroxide analysis by either gas or liquid chromatography as appropriate for the peroxide class or type. The solid organic peroxides and solid functionalized organic peroxides may exhibit ambient 20° C. stability so as not to lose any significant % assay in at least one month, preferably three months, as directly determined by either titration, gas chromatography or liquid chromatography depending upon the peroxide class.

The b) at least one non-polymeric bio-based additive is selected from the group consisting of: i) at least one natural oil or derivative thereof; ii) natural acids, iii) natural anhydrides, iv) esters of natural acids and anhydrides, and v) mixtures thereof;

Optional additives may be selected from the group consisting of coagents; sulfur containing compounds and/or elemental sulfur; and mixtures thereof.

Step B) may comprise, consist of, or consist essentially of combining the coupling agent formulation for wood-polymer composites with c) at least one carrier to form the coupling agent masterbatch for wood-polymer composites.

According to certain embodiments of the disclosure, the coupling agent formulation for wood-polymer composites may be in the form of a liquid and the at least one carrier may be in the form of solid particulates. The solid particulates may be selected from the group consisting of polyolefins, especially polyethylene (for example HDPE, LLDPE, MDPE and LDPE). However, ground solid polymer particulates from mixed recycled polymer waste streams may be considered for some embodiments. As is known in the art, polyethylene derived from plastic waste streams may comprise, in addition to the polyethylene, other polymers, for example, polystyrene, polyethylene terephthalate, polypropylene, scrap paper/cardboard. Other suitable solid particulates that may be used in certain embodiments are calcium carbonate, Burgess Clay, precipitated silica, microcrystalline cellulose fly ash, dried wood flour, dried saw dust; dried straw particles, recycled ground paper scrap, recycled ground/shredded cardboard scrap, recycled ground rug fiber scrap, recycled ground passenger/truck tires, and combinations thereof. The solid particulates may be selected from the group consisting of particulate polyethylene (e.g., granular polyethylene directly from a gas-phase reactor), wood flour, or sawdust. In certain embodiments of the disclosure, the step B) may comprise mixing a liquid coupling agent formulation with the at least one carrier in the form of solid particulates to form the coupling agent masterbatch, such that the coupling agent masterbatch may be in the form of solid particulates at 25° C. The coupling agent masterbatch thus may be in the form of free-flowing solid particulates.

According to another embodiment, the steps A) and B) may be performed at the same time, i.e., the at least one organic peroxide, the at least one non-polymeric bio-based additive and the at least one carrier material may be mixed together simultaneously. For example, these steps A) and B) may done in a low shear ribbon type blender, e.g., a Marion® type ribbon blender to form a coupling agent masterbatch including the particulates mentioned above to form a masterbatch. It is also possible to conduct the blending of the various components in a high shear Henschel® type blender to create a free flowing powder masterbatch.

The at least one organic peroxide may be selected from those as recited above or mixtures thereof. The at least one non-polymeric bio-based additives may be selected from those recited above or combinations thereof.

The combining step B) may comprise melt blending the various ingredients into a polymer. The melt blending may be conducted for example, in single-screw extrusion, twin-screw extrusion, ZSK mixer, Banbury mixer, Buss kneader, two-roll mill, or impeller mixing, or other type of suitable polymer melt blending equipment to produce the coupling agent masterbatch. The blending time and temperature conditions for the combining step B) may be selected such that the organic peroxide used does not decompose more than 4 wt %, preferably less than 2 wt % more preferably less than 1 wt %.

### Methods of Producing the Wood-Polymer Composites

A method of producing a wood-polymer composite is provided. The method comprises, consists of, or consists essentially of, a step I) of combining components A), B1) and C) to form a component mixture. A), B1) and C) comprises, consists of, or consists essentially of, the following: A) comprises, consists of, or consists essentially of, a non-polymeric coupling agent for the wood-polymer composite as disclosed herein. B1) comprises, consists of, or consists essentially of, a polymer matrix for a wood-polymer composite as disclosed above. C) comprises, consists of, or consists essentially of, at least one filler selected from those described above. The method also comprises, consists of, or consists essentially of, a step II) of forming the component mixture into a composite.

An alternate method of producing a wood-polymer composite is also provided. This alternate method is similar to the first method, but the alternate method comprises, consists of, or consists essentially of, using a coupling agent masterbatch. In particular, a step I) of combining components A), B2) and C) to form a component mixture. A), B2) and C) comprises, consists of, or consists essentially of, the following: A) comprises, consists of, or consists essentially of, a coupling agent masterbatch for the wood-polymer composites as disclosed herein. B2) comprises, consists of, or consists essentially of, a polymer matrix for a wood-polymer composite as disclosed above. C) comprises, consists of, or consists essentially of, at least one filler selected from those described above. The alternate method also comprises, consists of, or consists essentially of, a step II) of forming the component mixture into a composite.

In both of these methods of forming the wood-polymer composite, the combining step I) may be for example combining the components A) polymer matrix, C) the filler and either the non-polymeric coupling agent formulation B1) or the coupling agent masterbatch B2) in the feed to an extruder. For example the components may be metered directed into a hopper of an extruder, such the feed section of the extruder provides much of the combining step. The combining step may comprise dry-mixing the components, such as in a drum tumbler, or ribbon blender, or high shear blender and then feeding the dry mix in the hopper of the extruder. If the coupling agent formulation or the coupling agent masterbatch is in the form of a liquid, the liquid may be metered separately in the feed of the extruder, and the polymer matrix and the filler may be either directly combined into the extruder hopper, or separately dry-mixed. Other such methods as are known in the art and may be used in some embodiments. For example the components may be combined using melt blending, for example, in single-screw extrusion, twin-screw extrusion, ZSK mixer, Banbury mixer, Buss kneader, two-roll mill, or impeller mixing, or other type of suitable polymer melt blending equipment to produce the reaction mixture. The combining step may be a part of process to produce finished article, for example a extrusion through a die to form a solid wood-polymer composite board, or using a roll mill to create a sheet for use in thermoforming processes, or using blown film process, or compression molding process to create various parts. Other processes known in the art including injection molding, injection blow molding, thermoforming, or vacuum forming may be performed to create finished goods in some embodiments.

The forming step II) in either method of forming the composite may be for example extruding the component mixture through a die affixed to an extruder. The forming step may be a step of thermoforming, for example, using a set of heated dies. Other forming methods contemplated include injection molding, calendaring, blow molding, foaming, injection blow molding, vacuum forming, compression molding, and thermoforming. The composite may be polymer lumber, for example a deck board intended to be used in outdoor environments. Other useful article of manufacture include but are not limited to cladding, siding, outdoor furniture, exterior decking, interior flooring, indoor furniture, pallets, floors, railings, fences, molding, trim, window frames, door frames, landscaping timber, industrial cribbing, marine walls and pilings, boat slips, and wall paneling.

### Other Additives

Bio-based fillers, non-bio-based fillers, and/or stabilizers for the peroxides, whether bio-based or not may also be included in the non-polymeric coupling agent formulation for wood-polymer composites. For example calcium carbonate, talc, silica, fumed silica, precipitated silica, calcium carbonate, calcium silicate, diatomaceous earth, clay, Burgess clay, kaolin, fly ash, powdered polyethylene, or ground/powdered recycled passenger or truck tires, ground/powdered recycled rug fibers, ground recycled mixed polymer streams that may include small amounts of various polymers including polypropylene or poly(ethylene propylene) copolymer or poly(ethylene octene) copolymer or LDPE, or HDPE, or LLDPE; chopped fiberglass, ground paper, ground cardboard and/or ground scrap particle board may be used.

Other additives may be included to the wood-polymer composite formulation that are known to one of skill in the art, may include for example: colorants, mildew inhibitors, insecticides, other fillers besides wood flour, antioxidants, light/UV stabilizers, blowing or foaming agents, polymer flow aids, extrusion slip aids such as erucic acid amide, non-metal type lubricants such as ethylene bisstearimide; Glycolube® WP2200 from Lonza; Struktol® TPW 113 and Struktol® TPW 617 are non-limiting examples; fungcides such as (Folpet® from Zeneca Ag Products and Bethoxazin®)); process aids, mold release agents, antioxidants, anti-blocking agents, and the like. Suitable mold release agents known in the art include fatty acids, zinc, calcium and magnesium salts of fatty acids (e.g., zinc stearate). Mold release and slip agents may be added in an amount less than about 5 wt % based on the total weight of the final wood-polymer composite. Boric acid derivatives such as zinc borate may be effective in combating destructive brown rot fungus when used at 3 wt % to 5 wt % levels.

The non-polymeric coupling agent formulation may further comprise at least one sulfur containing compound to serve as a co-curing agent. Non-limiting examples of these co-curing agents are: disulfides, elemental sulfur, and sulfur containing amino acids. The Vanderbilt Rubber Handbook, thirteenth edition, 1990, R. T. Vanderbilt Company, Inc., publisher, the entire disclosure of which is incorporated by reference herein for all purposes, lists many types of sulfur containing compounds used for curing rubber. Non-limiting examples include monosulfides, 2-mercaptobenzothiazole (MBT), 2-2′-dithiobis(benzothiazole) (MBTS), disulfides, diallyldisulfide, polysulfides and the arylpolysulfide compounds such as the amylphenol polysulfides e.g. VULTAC® (Arkema). Specific examples include Vultac® 5, Vultac® 3, Vultac® 7, mercaptobenzothiazole disulfide (MBTS) and zinc dialkyldithiophosphate (ZDDP). Also included as co-curing agents are sulfur containing amino acid compounds, for example cysteine, methionine, homocysteine, taurine, n-formyl methionine and s-adenosylhomocysteine. The organic peroxide formulation may contain at least one sulfur containing compound, in particular at least one disulfide containing compound or elemental sulfur or a combination as a co-curing agent.

The non-polymeric coupling agent may also further comprise a coagent which may work in concert with the at least one organic peroxide. A crosslinking coagent has a function that is different from a peroxide: without wishing to be bound by theory, a coagent may be capable of being activated with the aid of a free radical initiator such as organic peroxides. Thus activated during the decomposition of the peroxide, it may then form crosslinking bridges with the polymer and is therefore may be integrated into the chain of the crosslinked polymer, unlike peroxides. Non-limiting examples of suitable coagents include allyl, acrylic, methacrylic and styrenic containing compounds. Monoallyl, diallyl and triallyl compounds may be considered. Non-limiting examples include: allylphenylether, epoxidized allylphenylether, allylmethacrylate monomers and oligomers (as sold by Sartomer), diallylmaleate, diallyldisulfide, diallyl itaconate, diallyl tartrate, diallyl phthalate, trimethylolpropane diallylether triallyltrimellitate, triallylcyanurate, partially epoxidized triallyl cyanurate, triallylisocyanurate, partially epoxidized triallylisocyanurate, and trimethylolpropane triallylether. Other non-limiting examples of such coagents are: alpha-methylstyrene dimer, or poly(methyl methacrylate) dissolved in methyl methacrylate monomer (available under the name Elium® from Arkema). Use of Elium® resin with at least one organic peroxide formulation is contemplated in this disclosure. Elium® may also be used in combination with the other components disclosed herein, e.g., the natural oils, natural solids, sulfur compounds, other coagents, elemental sulfur and/or acids.

Mixtures of any or all of these additives are contemplated.

Excluded from certain embodiments of this invention are “stand oils” made by polymerizing natural or bio-based oils. Polyester resins and those made using the various acids listed in the disclosure herein. Other exclusions from certain embodiments are water, added as a separate component to the formulation in amounts of about 5% about 4%, about 3%, about 2%, about 1% about 0.5% about 1000 ppm wt. Hydrogen peroxide is excluded. Inorganic peroxides are excluded. The intentional incorporation of water or the use of additives diluted with significant amounts of water is not desired in the practice of this invention. AIBN (azobisisobutyronitrile) or azo initiators are excluded. Any or all of these compounds may be present in the formulation for non-polymeric coupling agent formulation for wood-polymer composites at levels of not more than to 5 wt %, 4 wt %, 3 wt %, 2 wt %, for wt %, based on the total weight of the organic peroxide and the non-polymeric bio-based additive. Preferably, none of these compounds are present in the formulation.

### Standard Test Methods and Equipment Used in the Practice of this Invention

Standard Guide for Evaluating Mechanical and Physical Properties of Wood-PlasticComposite Products ASTM D7031-11 (2019). This ASTM standard guide discloses more than 38 test methods appropriate for evaluating a wide range of performance properties for wood-polymer composite (WPC) products. It is not intended to suggest that all the tests listed are necessary or appropriate for each application of a wood-polymer composite as disclosed herein.

The following test methods are used: ASTM D6109-19 (2019) Test Methods for Flexural Properties of Unreinforced and Reinforced Plastic Lumber and Related Products; ASTM D6341-98 (1998) Test Method for Determination of the Linear Coefficient of Thermal Expansion of Plastic Lumber and Plastic Lumber Shapes Between 30° F. and 140F (34.4° C. and 60° C.); ASTM D4442-16 (2016) Test Methods for Direct Moisture Content Measurement of Wood and Wood-Based Materials; ASTM D4761-19 (2019) Test Methods for Mechanical Properties of Lumber and Wood-Based Structural Materials (e.g. modulus of rupture: MOR); ASTM D1238-13 (2013) Standard Test Method for Melt Flow Rates of Thermoplastics by Extrusion Plastometer (used to determine polyethylene Melt Flow Index- MFI); ASTM D5289-19a (2019) Standard Test Method for Rubber Property-Vulcanization Using Rotorless Cure Meters (can be used for polyethylene); and ASTM D4440-15 (2015) Standard Test Method for Plastics: Dynamic Mechanical Properties Melt Rheology.

The invention further includes the following aspects:
Aspect 1: A method of producing a coupling agent masterbatch for wood-polymer composites, the method comprising:
A) combining:
a) at least one organic peroxide, wherein the organic peroxide has a half-life of at least one hour at 98° C. and;
b) at least one non-polymeric bio-based additive selected from the group consisting of i) at least one natural oil or derivative thereof; ii) at least one natural acid, anhydride or ester thereof; iii) at least one natural solid, and iii) mixtures thereof;
   to form a coupling agent formulation for wood-polymer composites;
   B) combining the coupling agent formulation for wood-polymer composites with c) at least one carrier to form the coupling agent masterbatch for wood-polymer composites.
   Aspect 2: The method according Aspect 1, wherein the coupling agent formulation for wood-polymer composites is in the form of a liquid; the at least one carrier is in the form of solid particulates; and the step B comprises mixing the liquid coupling agent formulation with the at least one carrier in the form of solid particulates to form the coupling agent masterbatch, wherein the coupling agent masterbatch is in the form of solid particulates at 25° C.
   Aspect 3: The method according to either Aspect 1 or 2, wherein steps A) and B) are performed at the same time.
   Aspect 4: The method according to any of Aspects 1-3, wherein the at least one carrier in the form of solid particulates is selected from the group consisting of polyolefins, polystyrene, calcium carbonate, Burgess Clay, precipitated silica, microcrystalline cellulose, fly ash, dried wood flour, dried saw dust; dried straw particles, and combinations thereof.
   Aspect 5: A method of producing a wood-polymer composite, the method comprising:
   I) combining components comprising:
A) a non-polymeric coupling agent for the wood-polymer composite according to any of Aspects 1-4;

B1) a polymer matrix; and
C) a filler;
to form a component mixture; and
   II) forming the component mixture into a composite.
   Aspect 6: The method of producing a wood-polymer composite according to Aspect 5, wherein step I) further comprises a step of feeding components A), B1), and C) to an extruder and step II) comprises a step of extrusion through a die.
   Aspect 7: A method of producing a wood-polymer composite, the method comprising:
   I) combining components comprising:
A) coupling agent masterbatch for wood-polymer composites according to any of Aspects 1 -6;
B2) a polymer matrix; and
C) a filler;
to form a component mixture; and
   II) forming the component mixture into a composite.
   Aspect 8: The method of producing a wood-polymer composite according to Aspect 7, wherein step I) further comprises a step of feeding components A), B2), and C) to an extruder and step II) comprises a step of extrusion through a die.

### ABBREVIATIONS USED IN THE EXAMPLES

Novacom-PTM HFS2100P is a high density polyethylene grafted with maelic anhydride from TWO H Chem.

Vul-Cup® 40KE is di(tert-butylperoxyisopropyl)benzene (40 weight %) on inert filler (kaolin clay) (Arkema).

Luperox® P is t-butylperoxybenzoate, (Arkema).

Luperox®231 is 3,3,5-trimethyl-1, 1-di(t-butylperoxy)cyclohexane (Arkema).

Luperox® TBEC is t-butyl-(2-ethylhexyl)-monoperoxycarbonate (Arkema).

Luperox® TAEC is t-amyl-(2-ethylhexyl)-monoperoxycarbonate (Arkema).

MOR is Modulus of Rupture

MOE is Modulus of Elasticity

psi is pounds per square inch

ksi is kilopounds per square inch

### TESTS AND PROCEDURES

### Sample Mixing Procedures

Wood flour (40M1 Hardwood 40 mesh wood flour, American Wood Fibers), was placed in a stainless steel pan in a vented oven and heated for 22-24 hours at 110° C. The dried wood flour, high density polyethylene , talc, zinc stearate, N,N′-ethylene bisstearamide, and other ingredients (including peroxide and additives) were weighed on an open-air balance and charged to a 1-gallon polyethylene bag (total mass of material for mixing =approximately 230 grams), the bag sealed, and bag shaken by hand (approximately 30 seconds) to provide initial mixing. The contents of the bag were then transferred to an internal mixer (Brabender Intelli Torque Plasticorder, 3 pieces, 350 cc Prep Mixer bowl, banbury blades, WinMix software) and mixed at 150° C. and 50 RPM until a stable torque measurement was reached. Material was backed out from and then added back to the mixing bowl, and mixed for a total of three minutes (50 RPM, 150° C.). Following subsequent removal of material from the bowl, final compounding was conducted using a press (Carver 15 ton model 3893; 10 seconds at 10 ksi and 150° C.).

### Plaque Preparation Procedures

Onto a 8″×8″×0.108″ stainless steel plate was placed a thinner metal sheet (8 ″×8″×0.035″), on top of which was placed a 8″×8″×0.016 mm sheet of aluminum foil. On top of the aluminum foil was placed a 8″×8″×0.125″ stainless steel plaque frame with inner cavity dimensions 6″×6″. Into the cavity of the plaque frame was placed approximately 90 grams of compounded wood plastic composite material, which was then covered with a layer of aluminum foil, a thin metal sheet, and a stainless steel plate. The entire plaque assembly was subjected to 15 Kpsi pressure for 13 minutes at 185° C. (Wabash Genesis 30 Ton G3OH press). The plaque frame and sample were removed from the press and allowed to cool to <35° C. Once cool, rectangular (4″×0.5″) strips of pressed material were cut (using a bandsaw) from the plaques for flexural testing.

### Physical Property Testing Procedures

Three-point flexural testing was conducted according to ASTM D790, using an Instron 33R 4204 incorporating a 2″ span, a 500N static load cell, and a flex rate of 0.5 in/minute. Reported values of Modulus of Rupture (MOR) and Modulus of Elasticity (MOE) are average values obtained from measurement of between three and five samples cut from each test plaque, with outliers (defined as exhibiting >5% deviation from the remaining measurements' average) excluded from calculation.

### EXAMPLES

### Comparative Example 1

Wood-polymer composition with comparative coupling agent. A composition containing 57 parts wood flour (40M1 Hardwood 40 mesh wood flour, American Wood Fibers), 32 parts high density polyethylene (Paxon® HDPE powder, ExxonMobil), 6 parts talc (magnesium silicate monohydrate, Alfa Aesar), 2 parts zinc stearate (Beantown Chemicals), 1 part N.N′-ethylene bisstearamide (Spectrum Chemicals), and 2 parts Novacom-PTM HFS2100P (coupling agent) were mixed using the procedures outlined above. Testing plaques were generated using the procedures above, and physical property testing revealed a modulus of rupture (MOR) of 3681 psi and a modulus of elasticity (MOE) of 499 ksi.

### Examples 1-6 (Of the Invention)

Examples 1-6 incorporate Vul-Cup® 40KE as the organic peroxide and organic anhydrides such as succinic anhydride, itaconic anhydride, and allylsuccinic anhydride as the non-polymeric bio-based additive. As shown in Table 1 Physical property testing, Examples 1-6 demonstrated increased MOR and MOE (with modulus increases of 15 to 102%) relative to the reference system, Comparative Example 1.

TABLE 1

| | Comparative | Example | Example | Example | Example | Example | Example |
|---|---|---|---|---|---|---|---|
| | Example 1 | 1 | 2 | 3 | 4 | 5 | 6 |
| Wood flour | 57 | 57 | 57 | 57 | 57 | 57 | 57 |
| High density polyethylene | 32 | 32 | 32 | 32 | 32 | 32 | 32 |
| Talc | 6 | 5 | 3 | 5 | 3 | 5 | 3 |
| Zinc stearate | 2 | 2 | 2 | 2 | 2 | 2 | 2 |
| Ethylene bisstearamide | 1 | 1 | 1 | 1 | 1 | 1 | 1 |
| Novacom-P ™ HFS2100P | 2 | | | | | | |
| Succinic anhydride | | 2 | 4 | | | | |
| Itaconic anhydride | | | | 2 | 4 | | |
| Allylsuccinic anhydride | | | | | | 2 | 4 |
| Vul-Cup ® 40KE | | 1 | 1 | 1 | 1 | 1 | 1 |
| Modulus of Rupture | 3681 | 5239 | 5462 | 6397 | 6771 | 7434 | 7371 |
| (psi) | | | | | | | |
| Modulus of Elasticity | 499 | 569 | 614 | 595 | 601 | 595 | 550 |
| (ksi) | | | | | | | |

### Examples 7-14 (Of the Invention)

Examples 7-14 incorporate Luperox® P, Luperox® 231, Luperox® TBEC, or Luperox® TAEC as the organic peroxide, and anhydrides such as itaconic anhydride or succinic anhydride as the non-polymeric bio-based additive, as identified in Table 2. Physical property testing on Examples 7-14 demonstrated significantly (15-72%) increased MOR and MOE relative to Comparative Example 1.

TABLE 2

| | Example | Example | Example | Example | Example | Example | Example | Example |
|---|---|---|---|---|---|---|---|---|
| | 7 | 8 | 9 | 10 | 11 | 12 | 13 | 14 |
| Wood flour | 57 | 57 | 57 | 57 | 57 | 57 | 57 | 57 |
| High density | 32 | 32 | 32 | 32 | 32 | 32 | 32 | 32 |
| polyethylene | | | | | | | | |
| Talc | 5.6 | 5.6 | 5.6 | 5.6 | 5.6 | 5.6 | 5.6 | 5.6 |
| Zinc stearate | 2 | 2 | 2 | 2 | 2 | 2 | 2 | 2 |
| Ethylene | 1 | 1 | 1 | 1 | 1 | 1 | 1 | 1 |
| bisstearamide | | | | | | | | |
| Succinic | | | | | 2 | 2 | 2 | 2 |
| anhydride | | | | | | | | |
| Itaconic | 2 | 2 | 2 | 2 | | | | |
| anhydride | | | | | | | | |
| Luperox ® P | 0.4 | | | | 0.4 | | | |
| Luperox ® 231 | | 0.4 | | | | 0.4 | | |
| Luperox ® TBEC | | | 0.4 | | | | 0.4 | |
| Luperox ® TAEC | | | | 0.4 | | | | 0.4 |
| Modulus of | 5071 | 6272 | 5084 | 4640 | 6322 | 5775 | 5876 | 4960 |
| Rupture (psi) | | | | | | | | |
| Modulus of | 572 | 663 | 605 | 591 | 612 | 600 | 624 | 584 |
| Elasticity (ksi) | | | | | | | | |

### Comparative Examples 2-6

Comparative Examples 2-6 (Table 3) incorporate itaconic anhydride or allylsuccinic anhydride as non-polymeric bio-based additive, but lack an organic peroxide. Physical property testing on Comparative Examples 2-6 showed reductions in MOR relative to the Comparative Example 1 (18 to 39% reductions vs. Comparative Example 1); Comparative Example 6 additionally shows a 19% reduction in MOE relative to Comparative Example 1.

TABLE 3

| | Comparative | Comparative | Comparative | Comparative | Comparative |
|---|---|---|---|---|---|
| | Example 2 | Example 3 | Example 4 | Example 5 | Example 6 |
| Wood flour | 57 | 57 | 57 | 57 | 57 |
| High density | 32 | 32 | 32 | 32 | 32 |
| polyethylene | | | | | |
| Talc | 6 | 4 | 6 | 4 | 6 |
| Zinc stearate | 2 | 2 | 2 | 2 | 2 |
| Ethylene bisstearamide | 1 | 1 | 1 | 1 | 1 |
| Succinic anhydride | 2 | 4 | | | |
| Itaconic anhydride | | | 2 | | |
| Allylsuccinic anhydride | | | | 4 | |
| Isononenylsuccinic | | | | | 2 |
| anhydride | | | | | |
| Modulus of Rupture (psi) | 2649 | 3025 | 3002 | 2820 | 2236 |
| Modulus of Elasticity (ksi) | 544 | 575 | 556 | 530 | 403 |

### Examples 15-19 (Of the Invention)

Examples 15-19 incorporate Vul-Cup® 40KE as the organic peroxide, and organic acids such as itaconic acid or succinic acid, or oleate derivatives such as sorbitan monooleate or sorbitan trioleate as the non-polymeric bio-based additive, as identified in Table 4. Physical property testing on Examples 15-19 revealed significantly increased MOR relative to Comparative Example 1 (6 to 92% increases relative to Comparative Example 1); Examples 15, 17, and 18 additionally show significantly increased MOE (8 to 11%) relative to Comparative Example 1.

TABLE 4

| | Example 15 | Example 16 | Example 17 | Example 18 | Example 19 |
|---|---|---|---|---|---|
| Wood flour | 57 | 57 | 57 | 57 | 57 |
| High density polyethylene | 32 | 32 | 32 | 32 | 32 |
| Talc | 4 | 5 | 3 | 5 | 5 |
| Zinc stearate | 2 | 2 | 2 | 2 | 2 |
| Ethylene bisstearamide | 1 | 1 | 1 | 1 | 1 |
| Itaconic acid | 2 | | | | |
| Tannic acid | | 2 | 4 | | |
| Sorbitan monooleate | | | | 2 | |
| Sorbitan trioleate | | | | | 2 |
| Vul-Cup ® 40KE | 1 | 1 | 1 | 1 | 1 |
| Modulus of Rupture (psi) | 7083 | 5233 | 5065 | 4201 | 3898 |
| Modulus of Elasticity (ksi) | 539 | 494 | 540 | 444 | 437 |

### Examples 20-27 (Of the Invention)

Examples 20-27 (Table 5) incorporate Vul-Cup® 40KE as the organic peroxide, and inorganics such potassium aluminum sulfate, borax (disodium tetraborate), or boric acid as the non-polymeric bio-based additive. Physical property testing on Examples 20-27 demonstrated significantly increased MOR and/or MOE relative to the Comparative Example 1. Examples 20-24 and 26-27 demonstrated 28-107% increases in MOR, and Examples 21-25 and 27 demonstrated 5-20% increases in MOE relative to the reference system. Examples 22 and 23 demonstrate that inorganics may be combined with organic acids to provide additional improvements to key physical properties. Examples 24-27 further demonstrate that formulations of the invention may comprise a polyethylene and another polymer, such as polyvinyl alcohol (PVA), or a polyethylene and silane additives, such as vinyl triethoxysilane and tetraethoxysilane.

TABLE 5

| | Example | Example | Example | Example | Example | Example | Example | Example |
|---|---|---|---|---|---|---|---|---|
| | 20 | 21 | 22 | 23 | 24 | 25 | 26 | 27 |
| Wood flour | 57 | 57 | 57 | 57 | 57 | 57 | 57 | 57 |
| High density | 32 | 32 | 32 | 32 | 32 | 32 | 32 | 32 |
| polyethylene | | | | | | | | |
| Talc | 6 | 5 | 6 | 5 | 5 | 5 | 3 | 4 |
| Zinc stearate | 2 | 2 | 2 | 2 | 2 | 2 | 2 | 1 |
| Ethylene | 1 | 1 | 1 | 1 | 1 | 1 | 1 | 1 |
| bisstearamide | | | | | | | | |
| Maleic acid | 2 | 4 | | | | | | |
| Polyvinyl alcohol | | | | | 1 | 1 | 2 | |
| Vinyl triethoxy | | | | | | | | 1 |
| silane | | | | | | | | |
| Tetraethoxy | | | | | | | | 1 |
| silane | | | | | | | | |
| Itaconic acid | | | 2 | 4 | | | | |
| Potassium | 3 | 3 | 3 | 3 | | | | |
| aluminum | | | | | | | | |
| sulfate | | | | | | | | |
| Borax | | | | | 1 | | | |
| Boric acid | | | | | | 1 | 2 | 2 |
| Vul-Cup ® 40KE | 1 | 1 | 1 | 1 | 1 | 1 | 1 | 1 |
| Modulus of | 6452 | 6172 | 7461 | 7261 | 4947 | 4729 | 5452 | 7108 |
| Rupture (psi) | | | | | | | | |
| Modulus of | 498 | 557 | 543 | 552 | 600 | 502 | 570 | 572 |
| Elasticity (ksi) | | | | | | | | |

### Comparative Examples 7-11

Comparative Examples 7-11 incorporate tannic acid, sorbitan monooleate, sorbitan trioleate, borax, or boric acid as non-polymeric bio-based additive, but lack an organic peroxide. Physical property testing on Comparative Examples 7-11 showed reductions in MOR and sometimes MOE relative to the comparative Example 1 as well as to the formulations in Examples 15-27 that contain organic peroxide.

TABLE 6

| | Comparative | Comparative | Comparative | Comparative | Comparative |
|---|---|---|---|---|---|
| | Example 7 | Example 8 | Example 9 | Example 10 | Example 11 |
| Wood flour | 57 | 57 | 57 | 57 | 57 |
| High density | 32 | 32 | 32 | 32 | 32 |
| polyethylene | | | | | |
| Talc | 4 | 4 | 4 | 6 | 6 |
| Zinc stearate | 2 | 2 | 2 | 2 | 2 |
| Ethylene bisstearamide | 1 | 1 | 1 | 1 | 1 |
| Polyvinyl alcohol | | | | 1 | 1 |
| Tannic acid | 4 | | | | |
| Sorbitan monooleate | | 4 | | | |
| Sorbitan trioleate | | | 4 | | |
| Borax | | | | 1 | |
| Boric acid | | | | | 1 |
| Modulus of Rupture | 2595 | 2027 | 2159 | 2473 | 2109 |
| (psi) | | | | | |
| Modulus of Elasticity | 412 | 308 | 330 | 434 | 413 |
| (ksi) | | | | | |

### Examples 28-31 (Of the Invention)

Examples 28-31 incorporate Vul-Cup® 40KE as the organic peroxide, and carnauba wax, casein, or castor oil as the non-polymeric bio-based additive, as identified in Table 7. Physical property testing on Examples 28-31 revealed significantly increased MOR relative to the Comparative Example 1 (7 to 38% increases vs. Comparative Example 1), and Examples 28-29 demonstrating significantly increased MOR (11-17% increases) relative to Comparative Example 1.

TABLE 7

| | Example | Example | Example | Example |
|---|---|---|---|---|
| | 28 | 29 | 30 | 31 |
| Wood flour | 57 | 57 | 57 | 57 |
| High density polyethylene | 32 | 32 | 32 | 32 |
| Talc | 5 | 3 | 3 | 5 |
| Zinc stearate | 2 | 2 | 2 | 2 |
| Ethylene bisstearamide | 1 | 1 | 1 | 1 |
| Carnauba wax | 2 | 4 | | |
| Casein | | | 4 | |
| Castor Oil | | | | 2 |
| Vul-Cup ® 40KE | 1 | 1 | 1 | 1 |
| Modulus of Rupture (psi) | 5064 | 4629 | 4692 | 3935 |
| Modulus of Elasticity (ksi) | 554 | 585 | 502 | 462 |

### Comparative Examples 12-14

Comparative Examples 12-14 incorporate carnauba wax, casein, or castor oil as non-polymeric bio-based additive, but lack organic peroxide. Physical property testing on Comparative Examples 12-14 showed decreased MOR relative to Comparative Example 1. Comparative Examples 12 and 15 additionally showed decreased MOE relative to Comparative Example 1. (Comparative Example 1; Table 8).

TABLE 8

| | Comparative | Comparative | Comparative |
|---|---|---|---|
| | Example 12 | Example 13 | Example 14 |
| Wood flour | 57 | 57 | 57 |
| High density polyethylene | 32 | 32 | 32 |
| Talc | 6 | 6 | 4 |
| Zinc stearate | 2 | 2 | 2 |
| Ethylene bisstearamide | 1 | 1 | 1 |
| Carnauba wax | 2 | | |
| Casein | | 2 | |
| Castor Oil | | | 4 |
| Modulus of Rupture (psi) | 2901 | 2867 | 1892 |
| Modulus of Elasticity (ksi) | 484 | 543 | 254 |

1. A non-polymeric coupling agent formulation for wood-polymer composites comprising:
a) at least one organic peroxide, wherein the at least one organic peroxide has a half-life of at least one hour at 98° C., and;
b) at least one non-polymeric bio-based additive selected from the group consisting of natural oils and derivatives thereof; natural acids, anhydrides and esters thereof; natural solids; and
mixtures thereof.

2. The non-polymeric coupling agent formulation for wood-polymer composites of claim 1, wherein the at least one organic peroxide comprises at least one functionalized organic peroxide.

3. The non-polymeric coupling agent formulation according to claim 1, wherein a) the at least one organic peroxide is selected from the group consisting of diacyl peroxides; peroxyesters; monoperoxycarbonates; peroxyketals; dialkyl peroxides; t-butylperoxides; t-amylperoxides; carboxylic acid functionalized peroxides; cyclic polyperoxides; hydroxyl functionalized peroxides; functionalized peroxides possessing a free radical reactive unsaturated group; and mixtures thereof.

4. The non-polymeric coupling agent formulation according to claim 1, wherein a) the at least one organic peroxide is selected from the group consisting of di(tert-butylperoxyisopropyl)benzene; tert-butylperoxybenzoate; 1,1-di-(tert-butylperoxy)-3,3,5-trimethylcyclohexane; 1,1-di(t-butylperoxy)cyclohexane; 1,1-di(t-amylperoxy)cyclohexane; tert-butyl-(2-ethylhexyl)-monoperoxycarbonate; tert-amyl-(2-ethylhexyl)-monoperoxycarbonate; t-butylcumylperoxide; t-butylperoxy -isopropenylcumylperoxide; 2,5-dimethyl-2,5-di(t-butylperoxy)hexyne-3; 2.5-dimethyl-2,5-di(t-butylperoxy)hexane; di-t-amyl peroxide; dicumyl peroxide; 3,6,9-triethyl-3,6,9-trimethyl-1,2,4,5,7,8-hexoxonane; 3,3,5,7,7-pentamethyl-1,2,4-trioxepane; t-butylperoxymaleic acid; and mixtures thereof.

5. The non-polymeric coupling agent formulation according to claim 1, wherein b) the at least one non-polymeric bio-based additive comprises i) at least one natural oil or derivative thereof selected from the group consisting of tung oil, oiticica oil, castor oil, limonene, lecithin, tung oil derivative, oiticica oil derivatives, limonene derivatives, lecithin derivatives; epoxidized soybean oil; partially epoxidized limonene oil, and mixtures thereof.

6. The non-polymeric coupling agent formulation according to claim 1, wherein b) the at least one non-polymeric bio-based additive comprises the at least one natural acid selected from the group consisting of abietic acid; itaconic acid; tartronic acid; succinic acid; allylsuccinic acid; isononenylsuccinic acid; tannic acid; and mixtures thereof.

7. The non-polymeric coupling agent formulation according to claim 1 wherein b) the at least one non non-polymeric bio-based additive comprises the at least one anhydride selected from the group consisting of succinic anhydride, itaconic anhydride, alkenyl succinic anhydrides, isononenyl succinic anhydride, and mixtures thereof.

8. The non-polymeric coupling agent formulation according to claim 1, wherein b) the at least one non-polymeric bio-based additive comprises at least one natural solid selected from the group consisting of aluminum sulfate, potassium aluminum sulfate, ammonium aluminum sulfate, aluminum hydroxide, sodium aluminum sulfate, tetrasodium borate, boric acid, alum, iron salts, carnauba wax, casein, and mixtures thereof.

9. The non-polymeric coupling agent formulation for wood-polymer composites of claim 1 further comprising at least one stabilizer selected from the group consisting of quinone compounds, nitroxide compounds, and mixtures thereof.

10. The non-polymeric coupling agent formulation for wood-polymer composites of claim 1 wherein the at least one stabilizer is selected from the group consisting of mono-tert-butylhydroquinone (MTBHQ); hydroquinone, hydroquinone mono-methyl ether (HQMME) (also known as 4-methoxy phenol); mono-t-amylhydroquinone;
hydroquinone bis(2-hydroxyethyl) ether; 4-ethoxy phenol; 4-phenoxy phenol; 4-(benzyloxy) phenol; 2,5-bis (morpholinomethyl) hydroquinone; benzoquinone, 4-hydroxy TEMPO, and mixtures thereof.

11. The non-polymeric coupling agent formulation of claim 1, which is a solid.

12. The non-polymeric coupling agent formation of claim 1 further comprising a lubricant.

13. A coupling agent masterbatch for wood-polymer composites comprising the non-polymeric coupling agent formation of claim 1; and c) at least one carrier for the non-polymeric coupling agent masterbatch.

14. The coupling agent masterbatch for wood-polymer composites according to claim 13, wherein c) the at least one carrier for the non-polymeric coupling agent masterbatch is selected from the group consisting of polyethylene, calcium carbonate, Burgess Clay, precipitated silica, microcrystalline cellulose, fly ash, wood flour, saw dust, straw particles, rice hulls, particulate polyethylene, powdered polyethylene, pelleted polyethylene, recycled polyethylene and combinations thereof.

15. The coupling agent masterbatch for wood-polymer composites according to claim 13, wherein a) the at least one organic peroxide is selected from the group consisting of diacyl peroxides; peroxyesters; monoperoxycarbonates; peroxyketals; dialkyl peroxides; t-butylperoxides; t-amylperoxides; carboxylic acid functionalized organic peroxides; cyclic polyperoxides; hydroxyl functionalized organic peroxides; functionalized organic peroxides possessing a free radical reactive unsaturated group; and mixtures thereof.

16. The coupling agent masterbatch for wood-polymer composites according to claim 13, wherein a) the at least one organic peroxide comprises di(tert-butylperoxyisopropyl)benzene; tert-butylperoxybenzoate; 1,1-di-(tert-butylperoxy)-3,3,5-trimethylcyclohexane; 1,1-di(t-butylperoxy)cyclohexane; 1,1-di(t-amylperoxy)cyclohexane; tert-butyl-(2-ethylhexyl)-monoperoxycarbonate; tert-amyl-(2-ethylhexyl)-monoperoxycarbonate; t-butylcumylperoxide; t-butylperoxy-isopropenylcumylperoxide; 2,5-dimethyl-2,5-di(t-butylperoxy)hexyne-3; 2.5-dimethyl-2,5butylperoxy)hexane; di-t-amyl peroxide; dicumyl peroxide; 3,6,9-triethyl-3,6,9-trimethyl-1,2,4,5,7,8-hexoxonane; 3,3,5,7,7-pentamethyl-1,2,4-trioxepane; t-butylperoxy maleic acid and mixtures thereof.

17. The coupling agent masterbatch for wood-polymer composites according to claim 13, wherein b) the at least one non-polymeric bio-based additive comprises i) at least one natural oil or derivative thereof selected from the group consisting of tung oil, oiticica oil, limonene, lecithin, tung oil derivative, oiticica oil derivatives, limonene derivatives, lecithin derivatives; epoxidized soybean oil; partially epoxidized limonene; and mixtures thereof.

18. The coupling agent masterbatch for wood-polymer composites according to claim 13, wherein b) the at least one non-polymeric bio-based additive comprises ii) at least one natural acid, anhydride, or ester thereof selected from the group consisting of abietic acid; itaconic acid; tartronic acid; abietic anhydride; itaconic anhydride; abalyn; and mixtures thereof.

19. A wood-polymer composite made using the non-polymeric coupling agent formulation for wood-polymer composites of claim 1, comprising at least one polymeric matrix; and at least one filler comprising at least one of wood particles, wood scrap particles, wood flour, saw dust, rice hull powder, straw powder, straw fibers, wheat straw, bamboo fiber, flax, jute, hemp, cellulose, ground wood, palm fiber, bagasse, peanut shells, chitin, kenaf fibers, scrap paper, cardboard, and mixtures thereof.

20. The wood-polymer composite according to claim 19, wherein the at least one polymeric matrix comprises at least one non-polar polymer selected from the group consisting of high density polyethylene (HDPE), medium density polyethylene (MDPE), low density polyethylene (LDPE), linear low density polyethylene (LLDPE), and mixtures thereof.

21. The wood-polymer composite according to claim 1 in the form of a deck board, railing, fencing, or siding.

22. A wood-polymer composite derived from:
a) at least one organic peroxide, or decomposition product thereof, wherein the organic peroxide has a half-life of at least one hour at 98° C.;
b) at least one non-polymeric bio-based additive selected from the group consisting of: i) at least one natural oil or derivative thereof; ii) at least one natural acid, anhydride, or ester thereof; iii) at least one natural solid, and iii) mixtures thereof of;
c) at least one polymeric matrix comprising at least one non-polar polymer selected from the group consisting of high density polyethylene (HDPE), medium density polyethylene (MDPE), low density polyethylene (LDPE), linear low density polyethylene (LLDPE), recycled polyethylene, and mixtures thereof; and
d) at least one filler comprising at least one of calcium carbonate, Burgess Clay, precipitated silica, fly ash, wood particles, wood product particles, wood flour, saw dust, rice hull powder, straw powder, straw fibers, wheat straw, bamboo fiber, flax, jute, hemp, cellulose, ground wood, palm fiber, bagasse, peanut shells, chitin, kenaf fibers, scrap paper, cardboard, and mixtures thereof.

23. A wood-polymer composite according to claim 22, wherein the composite is in the form of a deck board, railing, fencing, or siding.
